(19) United States
(12) Patent Application Publication
(10) Pub. No.: US 2011/0167905 A1
(43) Pub. Date: Jul. 14, 2011

(54) CASTING LEVEL MEASUREMENT IN A MOLD BY MEANS OF A FIBER OPTIC MEASURING METHOD

(75) Inventors: Matthias Arzberger, Mulheim a.d. Ruhr (DE); Dirk Lieftucht, Legden (DE); Uwe Plociennik, Ratingen (DE)

(73) Assignee: SMS SIEMAG AKTIENGESELLSCHAFT, Düsseldorf (DE)

(21) Appl. No.: 13/056,887

(22) PCT Filed: Jul. 30, 2009
(86) PCT No.: PCT/EP2009/005529

§ 371 Date: Feb. 18, 2011

(30) Foreign Application Priority Data
Jul. 31, 2008 (DE) 10 2008 035 608.5
Dec. 2, 2008 (DE) 10 2008 060 032.6

(51) Int. Cl. G01F 23/22

(52) U.S. Cl. 73/295

(57) ABSTRACT

The invention provides a method for the cast level measurement in a mold by means of sensors for fiber optic temperature detection, which are disposed in the mold copper plate at the height of the casting level. The invention further comprises respective sensors. Fiber optic cables are disposed in said sensors, which allow simple, reliable and highly locally resolved temperature monitoring at the height of the casting level by means of a suitable temperature analysis system. By means of the temperatures determined by the sensors, a conclusion can be made as to the exact height of the casting level. Furthermore, the shape of the casting level shaft may be determined by means of which further parameters of the casting process become accessible.

### TECHNICAL FIELD

The invention concerns a method for measuring the liquid level in a mold by one or more measuring fibers and/or sensors for fiber optic temperature measurement arranged in the mold copper plate at the level of the molten metal. The exact level of the molten metal can be derived from the temperatures determined by the fiber optic temperature sensors. The invention also includes the sensors used in this measuring method.

### PRIOR ART

A well-known standard method for determining the level of the molten metal uses radioactive particles introduced into the mold. In this method, the emitted radiation is measured at various heights in the mold, which makes it possible to determine the level of the molten metal. To improve the measurement, a greater density of such particles can be introduced into the mold.

Method of this type have the disadvantage that they must meet ever more stringent radiation protection laws. The use of radioactive materials hinders simple maintenance work and requires expensive sources of these materials. Moreover, these methods are not suitable for determining the form of a meniscus wave, from which useful information can be obtained about other casting parameters, for example, the casting rate.

In addition, methods are known in which the liquid level of the mold is determined by taking temperature measurements with thermocouples.

These methods have the disadvantage that in practice the thermocouples cannot be arranged at very narrow intervals. Moreover, each individual test point requires a separate thermocouple, which leads to considerable material expense and above all a great deal of wiring work. Finally, the thermocouples are also susceptible to the magnetic fields of an electromagnetic brake or electromagnetic stirring coils. Furthermore, during the routine changing of the mold, a complicated reconnection of the cables is necessary, and this brings with it the risk that connection mistakes could be made or that some connections could be forgotten.

EP 1 769 864 describes a method for determining the liquid level of a continuous casting mold that involves the use of a camera. The camera is directed at the rear side of the copper plate of a mold, and the color changes of the copper plate in the infrared range are detected. A disadvantage of such a system is that a camera system of this type needs a lot of space. Besides, monitoring the liquid level is made much more difficult in general by cooling water components behind the mold copper plate. If optical fibers are used in accordance with this method in order to guide the infrared radiation directly from points of the copper plate of the mold to the camera, each test point requires an optical fiber that leads to the camera and must be correctly connected.

The early disclosure DE 26 55 640 discloses a device for determining the molten metal level in a continuous casting mold, which employs a detector element that consists of a thermosensitive magnetic material. The temperature change in the mold wall ultimately makes it possible to derive the liquid level. The large-scale setup of this system makes highly locally resolved determination of the liquid level impossible. In addition, this method is susceptible to disturbances with respect to external magnetic fields as set forth above. Even with several of these devices, it is not possible to obtain sufficient information about the form of the meniscus wave.

JP 09 085406 discloses a method for determining the height of the liquid level of a continuous casting mold, in which several optical fibers arranged in slots are placed on the broad sides and the narrow sides of the mold to measure the luminous density. A connected automatic control system serves to analyze the distribution of the luminous density, to automatically control the casting rate, and thus to determine the height of the liquid level.

JP 04 351 254 and JP 06 294685 describe a device for measuring the height of the liquid level in a continuous casting mold, in which at least one optical fiber is arranged on the hot side of the mold over the entire height of the mold and is connected with a temperature analysis system to automatically control the height of the liquid level.

DE 28 54 515 uses the heat radiation of the molten metal to determine the height of the liquid level. The information about the temperature distribution is picked up by infrared level sensors and transmitted as analog or digital electrical signals to the signal processing unit.

The technical objective that thus presents itself is to eliminate the disadvantages specified above.

### DISCLOSURE OF THE INVENTION

The technical objective formulated above is achieved by the present invention with a method for measuring the liquid level in a metal casting mold, wherein the height of the liquid level is determined by determining the temperature distribution in the region of the liquid level over the height of the mold in the casting direction. This method is characterized by the fact that this temperature determination is made by means of one or more measuring fibers and/or by means of at least one test sensor, which is installed the mold copper plate and comprises fiber optic sensors, and that an analysis unit uses the temperature distribution thus obtained to determine the height of the liquid level.

This method allows reliable and highly locally resolved determination of the liquid level in a mold. The radiation guidelines that must be considered in connection with radioactive detection methods are no longer a concern. Moreover, the system has greater local resolution than would be possible with thermocouples. In addition, the wiring work involved in such systems is eliminated. There is no susceptibility to disturbance by surrounding magnetic fields. The system can be easily integrated in an existing mold copper plate and can be reused as well.

In a preferred embodiment of the method, to automatically control the start of casting, at least one additional test sensor for temperature determination is installed in the region of the lower end of the mold, said sensor comprising fiber optic sensors and/or thermocouples.

This type of advantageous feature makes it possible to control the start casting operation and with the use of fiber optic sensors has the aforementioned advantages over the previously known methods.

In another preferred embodiment of the method, at least two test sensors are arranged in the width direction, perpendicular to the casting direction, so that the height of the liquid level can be determined at least at two test points in the width direction, which makes it possible to obtain information about the form of a meniscus wave.

Due to the high local resolution, this type of system of fiber optic sensors or probes makes it possible to determine the form of a meniscus wave, and this makes it possible to derive the casting rate. With the aid of a closed-loop control system, it is thus also possible to control, for example, an electromagnetic brake.

In another preferred embodiment of the method, the fiber Bragg grating method (FBG method), the optical time domain reflectometry method (OTDR method), or the optical frequency domain reflectometry method (OFDR method) is used for the analysis.

In another preferred embodiment of the method, the data of the analysis unit is transmitted to an automatic control system that can control the height of the liquid level in the mold.

Besides the method, the invention claims a sensor for determining the height of the liquid level by determining the temperature in a metal casting mold in the region of the liquid level, which is characterized in that the sensor is provided with at least one optical fiber and can be installed in the copper plate of a mold. The use of a sensor of this type makes it possible, among other things, to realize the advantageous effects specified above.

In a preferred embodiment, the sensor has an essentially rectangular solid shape, so that it can be installed in a groove on the side of the mold copper plate that faces away from the molten metal.

In another preferred embodiment, several parallel grooves are provided in the part of the sensor that contacts the copper plate in the direction of the liquid level. The parallel grooves run perpendicularly to the liquid level, and one or more optical fibers are arranged in each groove.

In another preferred embodiment, at least one optical fiber is arranged in each groove, and the optical fibers are arranged in such a way that they are offset lengthwise in the grooves.

This arrangement makes it possible to further increase the number of test points perpendicular to the liquid level.

In another preferred embodiment, the sensor has essentially the shape of a cylinder. The one or more optical fibers are wound spirally around this cylinder, and the sensor can be inserted in a drill hole in the copper plate of the mold.

The winding of the optical fibers on this type of sensor makes it possible to increase the density of the test points perpendicular to the liquid level as a function of the density or angle of the winding.

In another preferred embodiment, several optical fibers are wound spirally around the cylinder, and the optical fibers are wound in discrete regions one after the other on the cylinder.

In another preferred embodiment, the sensor has the shape of a plate, which can be arranged on the side of the mold copper plate that faces away from the molten metal or can be arranged in a slot in the mold copper plate, where the one or more optical fibers are arranged on the side of the sensor that is in contact with the mold copper plate.

This type of sensor can also provide temperature information in the width direction.

In another preferred embodiment, the one or more optical fibers are arranged in a meandering and/or spiral pattern on the plate.

An arrangement of this type makes it possible to increase the density of the possible test points on the plate.

In another preferred embodiment, the one or more optical fibers are arranged on the sensor in grooves.

In another preferred embodiment, the sensor is formed by the one or more optical fibers, which can be arranged directly in at least one drill hole in the copper plate of the mold.

### BRIEF DESCRIPTION OF THE DRAWINGS

The accompanying drawings of specific embodiments are briefly described below, and the specific embodiments illustrated in the drawings are then described in greater detail in the description which follows this brief description.

FIG. 1a shows a specific embodiment of a sensor of the invention, which is to be mounted in a groove in the copper plate of the mold.

FIG. 1b is a top view of the region of FIG. 1a that is provided with test points.

FIG. 2 shows another embodiment of a sensor of the invention for installation in a drill hole in a copper plate of the mold.

FIG. 3a shows another embodiment of a sensor of the invention, which has the form of a plate.

FIG. 3b shows an embodiment of the sensor from FIG. 3a in a top view of the side of the sensor that faces the molten metal, in which an optical fiber is arranged spirally in grooves in the plate.

FIG. 3c shows another embodiment of a sensor according to FIG. 3a, in which optical fibers are arranged in a meandering pattern in grooves on the side of the sensor that faces the molten metal.

FIG. 3d shows another embodiment of a sensor according to FIG. 3a, in which basically several optical fibers are arranged in grooves on the side that faces the molten metal.

FIG. 4 is a schematic three dimensional cross section of a mold in accordance with a specific embodiment of the invention, in which a sensor according to FIG. 1 is installed in a copper plate of a broad side of the mold.

FIG. 5 is a schematic three dimensional cross section of a mold in accordance with another specific embodiment of the invention, in which a sensor according to FIG. 2 is installed in a drill hole in a copper plate on the broad side of the mold.

FIG. 6 is a schematic three dimensional cross section of a mold in accordance with another specific embodiment of the invention, in which a sensor according to one of FIGS. 3a, 3b, 3c or 3d is installed in the copper plate of a broad side of the mold, on the side that faces away from the molten metal.

FIG. 7 is a schematic three dimensional cross section of a mold in accordance with another specific embodiment of the invention, in which a sensor is provided in a copper plate of the broad side of a mold, where the sensor consists of a single optical fiber, which is installed in a drill hole that runs perpendicularly to the liquid level.

### DETAILED DESCRIPTION OF THE SPECIFIC EMBODIMENTS

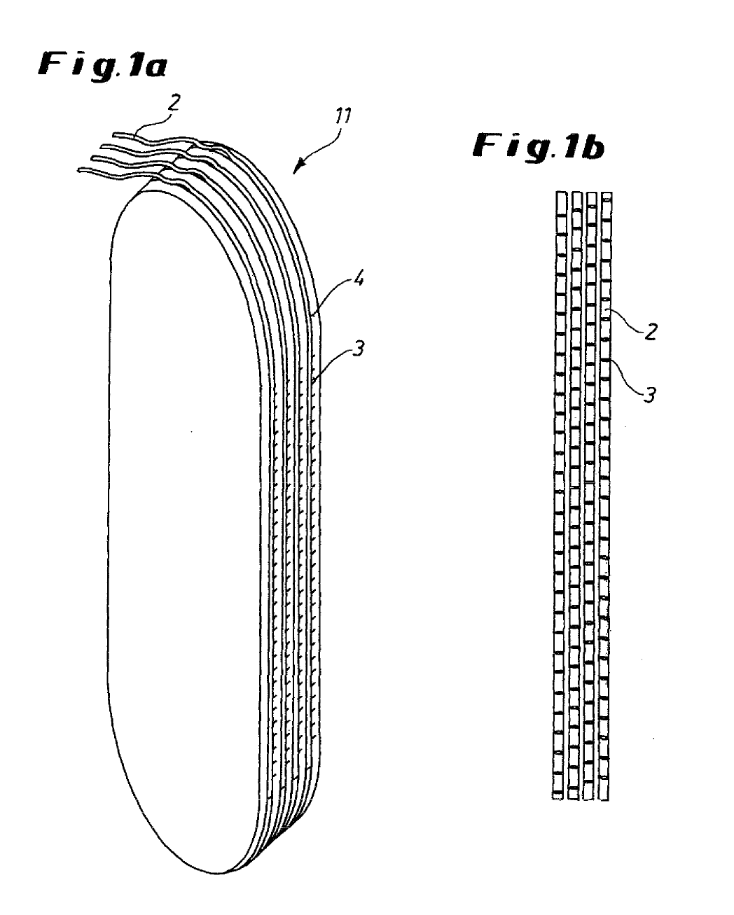

FIG. 1a shows a specific embodiment of a sensor 11 of the invention. The sensor 11 is shaped basically like a rectangular solid that is rounded at the upper and lower ends. The sensor 11 has four grooves 4, each of which contains an optical waveguide (optical fiber) or a fiber optic sensor 2. The drawing also shows test points 3 at which the temperature can be determined. The sensor 11 can be installed, for example, in a groove in the side of a mold copper plate that faces away from the molten metal, so that the optical fibers 2 are oriented in the direction of the molten metal. The sensor 11 is installed in such a way that the optical fibers 2 are in direct contact with the copper plate and are arranged between the water-cooling system of the copper plate and the molten metal in the direction of the molten metal. The sensor 11 illustrated in the drawing can have other geometries as well, as long as it is suited for installation in a groove of a mold copper plate. The sensor or groove sensor 11 can also be integrated in existing systems, in which it (also in addition to existing systems of temperature monitoring) is mounted in a groove in a copper plate.

FIG. 1b is an enlarged top view of the region of FIG. 1a in which the test points 3 of the optical fibers 2 are located. In this embodiment, the entire vertical dimension of this region is 120 mm. The four optical fibers 2 are arranged side by side in this region. The entire width of the region illustrated here is about 5 mm, which means that the sensor 11 is very compact. The distance between the individual parallel optical fibers 2 and thus the widthwise spacing between the test points 3 is about 1 mm. The vertical spacing between the test points 3 of an optical fiber 2 is 4 mm in the illustrated embodiment. However, due to the advantageous displacement of the optical fibers 2, test points 3 are present at intervals of 1 mm in the vertical direction, since the four parallel optical fibers 2 are arranged with a lengthwise offset of 1 mm. 120 test points are thus obtained for a length of 120 mm. The spacing of the optical fibers 2, the size of the sensor 11, the number of grooves 4 and optical fibers 2, and the spacing of the test points 3 can also be selected differently, depending on the application, so that any desired densities of test points 3 can be realized. All of the specified dimensions are meant only to better explain the embodiment.

Furthermore, it is possible, to improve the local resolution, to arrange several optical fibers 2 with offset within a groove 4. The accuracy of the temperature determination can be still further improved in this way.

In general, the diameter of the grooves 4 is preferably 0.5 mm to 10 mm or could even be several centimeters, depending on the application.

The optical fibers 2 shown in FIGS. 1a and 1b are connected with a suitable temperature analysis system, where laser light is guided into the optical fibers 2, and the temperature along each optical fiber can be determined by means of a suitable method of analysis. Possible methods of analysis for the fiber optic measuring method include, for example, the well-known fiber Bragg grating method (FBG method). In this method, optical fibers 2 are used, which are impressed with test points with a periodic variation of the index of refraction or a grating with such variations. Test points 3 of this description are illustrated in FIGS. 1a and 1b. Due to this periodic variation of the index of refraction, the optical fiber 2 represents a dielectric reflector for certain wavelengths at the test points 3 as a function of the periodicity. As a result of a temperature change at a point, the Bragg wavelength is changed, and precisely this is reflected. Light that does not satisfy the Bragg condition is not significantly affected by the Bragg grating. The different signals of the various test sites 3 can then be distinguished from one another on the basis of transit time differences. The detailed design of fiber Bragg gratings of this type and the corresponding analysis units are widely known. The accuracy of the local resolution is a function of the spacing of the impressed test points.

Alternatively, the optical frequency domain reflectometry method (OFDR method) or the optical time domain reflectometry method (OTDR method) can be used to measure the temperature. These two methods are based on the principle of fiber optic Raman backscattering, which exploits the fact that a temperature change at the point of an optical fiber 2 causes a change in the Raman backscattering of the optical fiber material. With the aid of the analysis unit, for example, a Raman reflectometer, the temperature values along a fiber 2 can then be determined with local resolution. In this method, an average value is taken over a certain length of the fiber 2, and a test point 3 thus extends over a certain region of the fiber 2. This length is presently a few centimeters. The different test points are separated from one another by transit time differences. The design of systems of this type for analysis by the aforementioned methods is widely known, as are the required lasers that generate the laser light within the fibers 2.

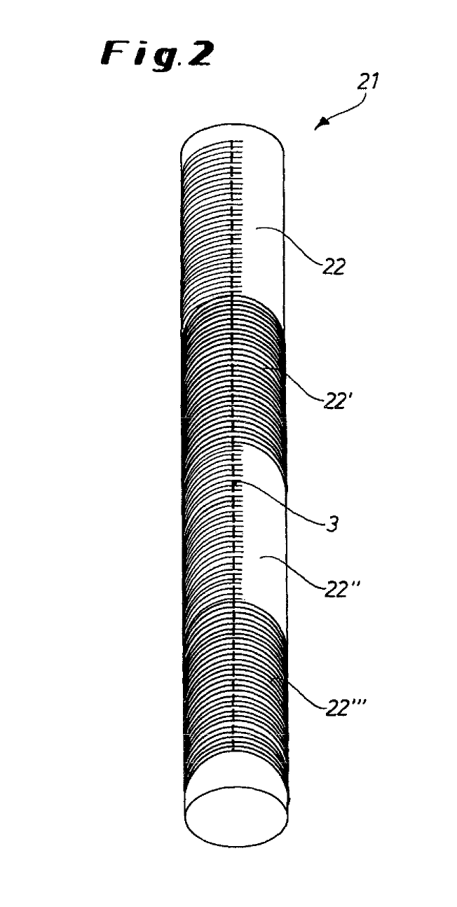

FIG. 2 shows another embodiment of a sensor for measuring temperature in accordance with the invention. The illustrated sensor 21 essentially has the shape of an elongated cylinder or rod on which the optical fiber 2 is spirally wound. It is also possible to provide these optical fibers 2 in the same form in grooves on the surface of the cylinder. In particular, FIG. 2 shows four optical fibers 2 wound on the cylinder. Each of these four individual optical fibers is arranged in a zone (22, 22′, 22″, 22′″) that is monitored only by this one optical fiber 2. The spiral arrangement of the optical fibers allows a greater density of test points 3 perpendicular to the liquid level; this is an advantages especially in the OTDR and OFDR methods. The connections of the optical fibers 2 are not visible in the drawing. A sensor 21 of this type can then be installed, perpendicularly to the liquid level, in a drill hole in a mold copper plate. The drill hole should be selected minimally greater than the diameter of the sensor 21, including the optical fiber 2, depending on the application. In particular, the sensor 21 shown in FIG. 2 has a measurement zone with optical fibers 2 that is 120 mm long, which is divided into four zones (22, 22′, 22″, 22′″) of 30 mm each. In this connection, the illustrated sensor 21 is wound in just such a way that the test points 3 are located on the side of the sensor that faces the molten metal. These test points 3 lie on a line and are spaced 1 mm apart. Accordingly, 120 test sites are located on the sensor 21 along a length of 120 mm. Furthermore, it is also possible to provide only one optical fiber 2 on the surface of the sensor 21 or in corresponding grooves. A different number of optical fibers 2 in the zones (22, 22′, 22″, 22′″) and different numbers of zones (22, 22′, 22″, 22′″) are also possible. All of the dimensions are meant only to serve the purpose of better understanding. The sensor 21 can be installed at any height of the mold for monitoring the temperature, but especially at the height of the liquid level, which makes it possible to determine the exact level of the molten metal. The information gathered by the sensor 21 is analyzed by one of the methods described in connection with FIGS. 1a and 1b.

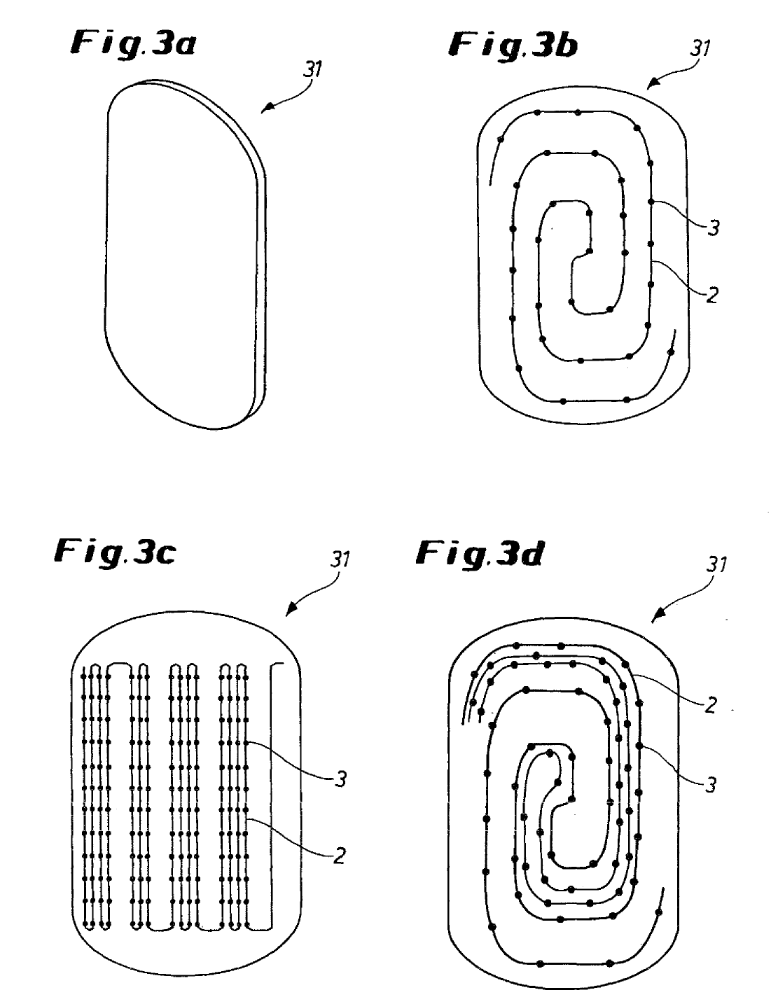

FIG. 3a shows another embodiment of a sensor in accordance with the invention. This sensor 31 essentially has the form of a plate or is planar in shape. A sensor 31 of this type can be installed either on the side of the copper plate that faces away from the molten metal or in a slot in the copper plate. As illustrated by way of example in FIGS. 3b, 3c and 3d, optical fibers 2 are arranged on the sensor in suitable grooves that are in contact with the mold copper plate in the direction of the molten metal.

The optical fibers 2 or the grooves can be arranged in a spiral pattern, as shown in FIG. 3b. The drawing also shows several test points 3 of the optical fiber 2 in the case of analysis by the FBG method. Similarly, the analysis can be carried out by the OTDR method or the OFDR method for all of the embodiments illustrated in FIGS. 3a to 3d.

FIG. 3c shows an arrangement similar to that of FIG. 3b but with a meandering arrangement of the optical fibers 2 or grooves. To monitor the liquid level, the sensor 31 with the optical fibers 2 is preferably arranged in such a way that as many optical fibers as possible are oriented perpendicularly to the liquid level, which allows an exact measurement of the level. In addition, due to the areal arrangement of the optical fibers 2 on the plate-shaped sensor 31, resolution of the liquid level in the width direction is achieved, and this enhances the ability to obtain information about the form of the meniscus wave.

FIG. 3d shows another possible arrangement of optical fibers 2 on a plate-shaped sensor 31, where two or more optical fibers 2 are arranged spirally on the plate or in grooves. In this case, one of the optical fibers is laid in a loop, so that its beginning and end are located in the same place.

In the embodiments illustrated in FIGS. 3a, 3b, 3c and 3d, it is also possible to provide several optical fibers 2 in one groove. Moreover, these optical fibers 2 can be arranged with lengthwise offset to further increase the number and density of the test points.

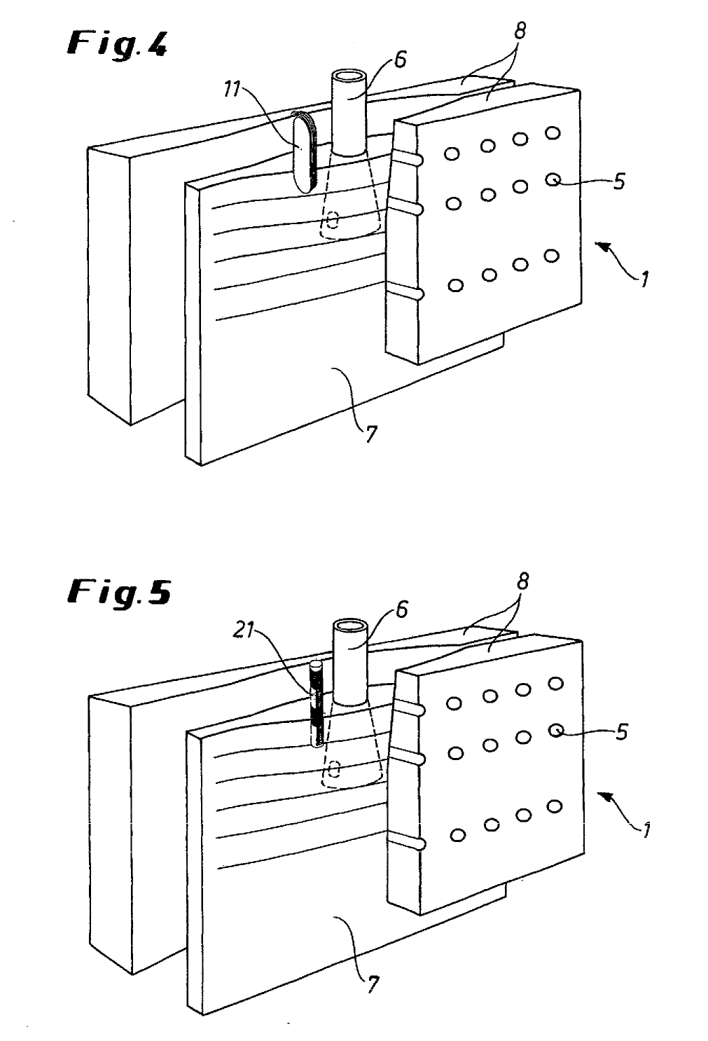

FIG. 4 is a schematic representation of the mounting situation of a sensor 11 according to FIG. 1. The drawing shows the copper plates 8 of the broad sides of the mold 1, the molten metal 7, and the pouring spout 6. The pouring spout 6 opens into the molten metal 7 below the liquid level. The molten metal 7 flowing out and the overall downward movement of the molten metal 7 in the mold often lead to the formation of a wave or a standing wave at the height of the liquid level. A sensor 11 according to FIG. 1 is installed at the height of the liquid level. This sensor 11 is installed in a groove in the mold copper plate and is preferably arranged in such a way that it can measure the temperature of the copper plate 8 in the direction of the molten metal 7 without being unduly affected by a water-cooling system behind it. Therefore, the drawing is to be viewed only as schematic. The regions 5 visible in the broad sides of the mold are holes for necked-down bolts or sites at which, for example, thermocouples can be installed for temperature measurement. However, these cannot be used for determining the liquid level.

FIG. 5 is a schematic representation of the mounting situation of a sensor 21 according to FIG. 2. The arrangement of the mold itself is the same as in FIG. 4, but the sensor 21 that is used is installed in a drill hole in a mold copper plate 8 on the broad side of the mold 1. The sensor 21 is installed in such a way that it covers a zone above and below the liquid level, as does the sensor 11 in FIG. 4. Thus, only the copper of the copper plate 8 is located between the sensor 21 and the liquid level or the molten metal 7, so that an exact temperature determination is possible.

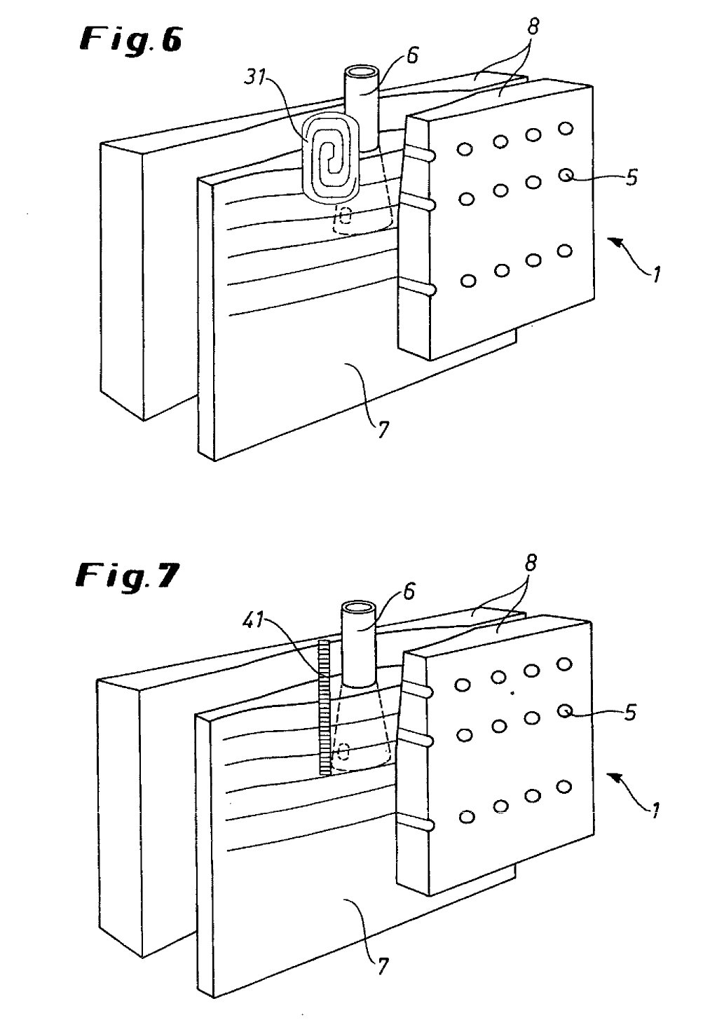

FIG. 6 shows the arrangement of a sensor 31 according to FIG. 3 in a mold copper plate 8 on the broad side of the mold. The sensor 31 is installed in a slot of the corresponding mold copper plate that is perpendicular to the liquid level, and the fiber optic sensors 2 are placed on the side of the sensor 31 that faces the molten metal. The plate with the sensors 2 could also generally be installed in a suitable recess on the side of the mold copper plate 8 that faces away from the molten metal 7. The sensor 31 thus covers a measurement zone above and below the molten metal 7. In addition, a sensor 31 arranged in this way can also yield information perpendicular to the casting direction or in the width direction of the liquid level. This makes it possible to obtain information about the shape and the variation of a meniscus wave that arises. This is also possible with the sensors in FIGS. 1, 2 and 7, but then several of these sensors are arranged perpendicularly to the casting direction at the height of the liquid level.

FIG. 7 shows another sensor 41 of the invention in a broad side of a mold copper plate 8. This sensor 41 consists of an optical fiber 2 that is installed in a drill hole perpendicularly to the liquid level in the region of the liquid level. Drill holes for this purpose can have a diameter that is only slightly greater than the diameter of an optical waveguide or an optical fiber or an optical waveguide including a possible casing, e.g., of high-grade steel.

Depending on the specific nature of the mold, the measurement zone that should be covered with all of the sensors of the embodiments described here preferably ranges from 100 mm to 200 mm but can be selected larger or smaller.

It is possible to install sensors of these types at every level in the mold, for example, even in the lower region of the mold. This region can extend, for example, from 0 mm to 900 mm from the lower edge of the mold. With a sensor installed in this way, the start of the casting operation can be better characterized and controlled.

All of the illustrated embodiments of sensors are reusable. This means that during a change of the mold copper plate, which must be done on a regular basis, the sensors, including the optical fibers, can be removed by simple means and reinstalled in a new mold, which makes the sensors of the invention especially cost-effective. The sensors preferably consist of a heat-conducting material, e.g., high-grade steel or copper.

In addition, it is generally possible for the optical fibers 2 to be provided with a casing of high-grade steel for the purpose of improved protection against external influences. It is also generally possible to place several of these optical fibers 2 within a casing or sheath of high-grade steel, so that even in the event of rarely occurring defects of a fiber, another fiber that is already placed in the sheath can continue to be used. Moreover, it is possible for several fibers to be arranged within a sheath for measurement, which further increases the accuracy of the measurement, since this makes it possible to select the spacing of the test points as narrow as desired by offsetting the fibers. The optical fibers 2 preferably have a diameter of 0.1 mm to 0.2 mm or otherwise customary diameters. The diameter of a sheath, e.g., a sheath made of high-grade steel, is usually less than 5 mm.

In addition, the optical fibers can be connected with the analysis unit by lens couplings, so-called extended-beam connectors. Couplings of this type allow reliable signal transmission and are very robust and easy to handle.

### LIST OF REFERENCE NUMBERS

1 mold
2 optical fiber
3 test point
4 groove
5 necked-down bolt
6 pouring spout
7 molten metal
8 mold copper plate
11 sensor
21 sensor
22 first zone
22′ second zone
22″ third zone
22′″ fourth zone
31 sensor
41 sensor

1-15. (canceled)

16. A method for measuring the liquid level in a metal casting mold, comprising the steps of: determining a temperature distribution over a height of the mold in a region of the liquid level, wherein the temperature determination is made by at least one measuring fiber and/or by at least one test sensor, which is installed in a copper plate of the mold and comprises fiber optic sensors; and determining a height of the liquid level in an analysis unit that uses the temperature distribution thus obtained.

17. The method in accordance with claim 16, including installing at least one additional test sensor for temperature determination in a region of a lower end of the mold for automatically controlling a start of casting, the test sensor comprising fiber optic sensors and/or thermocouples.

18. The method in accordance with claim 16, including arranging at least two test sensors in a width direction, perpendicular to a casting direction, so that the height of the liquid level can be determined at least at two test points in the width direction, which make obtaining information about a form of a meniscus wave possible.

19. The method in accordance with claim 16, including using the fiber Bragg grating method, the optical time domain reflectometry method, or the optical frequency domain reflectometry method for the analysis.

20. The method in accordance with claim 16, including transmitting data of the analysis unit to an automatic control system that controls the height of the liquid level in the mold.

21. A sensor for determining the height of a liquid level by determining temperature in a metal casting mold in a region of the liquid level, wherein the sensor comprises at least one optical fiber, is installed in a copper plate of a mold, and is connected with an analysis unit for determining the height of the liquid level.

22. The sensor in accordance with claim 21, wherein the sensor has an essentially rectangular solid shape, the sensor being installed in a groove on a side of the mold copper plate that faces away from molten metal in the mold.

23. The sensor in accordance with claim 22, wherein several parallel grooves are provided in a part of the sensor that contacts the copper plate in a direction of the liquid level, so that the parallel grooves run perpendicularly to the liquid level, and at least one optical fiber is arranged in each groove.

24. The sensor in accordance with claim 23, wherein at least one optical fiber is arranged in each groove, and the optical fibers are arranged so as to be offset lengthwise in the grooves.

25. The sensor in accordance with claim 21, wherein the sensor has a cylinder shape, and the at least one optical fiber is wound spirally around the cylinder, and the sensor is inserted in a drill hole in the copper plate of the mold.

26. The sensor in accordance with claim 25, wherein several optical fibers are wound spirally around the cylinder, and the optical fibers are wound in discrete regions one after the other on the cylinder.

27. The sensor in accordance with claim 21, wherein the sensor has a plate shape, and is arranged on a side of the mold copper plate that faces away from the molten metal or is arranged in a slot in the mold copper plate, wherein the at least one optical fiber is arranged on the side of the sensor that is in contact with the mold copper plate.

28. The sensor in accordance with claim 27, wherein the at least one optical fiber is arranged in a meandering and/or spiral pattern on the plate.

29. The sensor in accordance with claim 27, wherein the at least one optical fiber is arranged on the sensor in grooves.

30. The sensor in accordance with claim 21, wherein the sensor is formed by the at least one optical fiber, which is arranged directly in at least one drill hole in the copper plate of the mold.
